(19) United States
(12) Patent Application Publication
(10) Pub. No.: US 2006/0009604 A1
(43) Pub. Date: Jan. 12, 2006

(54) Oligomer silasesquioxanes, method for the production thereof, and use of the same

(75) Inventors: Carsten Jost, Dusseldorf (DE); Adolf Kuhnle, Marl (DE); Hendrikus Cornelis Louis Abbenhuis, Nuenen (NL)

Correspondence Address: FITCH, EVEN, TABIN & FLANNERY, P. O. BOX 65973, WASHINGTON, DC, 20035, US

(73) Assignee: Degussa AG, Dusseldorf (DE)

(21) Appl. No.: 11/176,445

(22) Filed: Jul. 8, 2005

Related U.S. Application Data
(63) Continuation of application No. PCT/EP03/00133, filed on Jan. 9, 2003.

(51) Int. Cl. C08G 77/04

(52) U.S. Cl. 528/33

(57) ABSTRACT

The invention is directed to processes that can be used for the production of silasesquioxanes using a base catalyzed reaction of monomeric compounds.

Oligomeric silasesquioxanes may be used for the synthesis and modification of polymers with a wide field of application. The resulting polymers may be used for example in coatings and adhesives, in moulded articles made of plastics materials, in fibres or packaging materials. Since the silasesquioxanes can be produced in a large variety as regards their structure, the properties of the polymers that can be produced from silasesquioxanes and/or modified therewith can be influenced over a wide range. Numerous thermal and mechanical properties of polymers can be improved by the copolymerisation, grafting or blending of silasesquioxanes, in which connection there may for example be mentioned the various moduli, temperature stability, adhesion properties with respect to a large number of materials, oxidation stability and scratch resistance and tear strength.

Recently metal-containing silasesquioxanes have also become increasingly important as regards their possible use as catalysts (Chem. Eur. J. 2000, 6, 25-32).

As Voronkov and Lavrent'yev describe, the synthesis of completely condensed oligomeric silasesquioxanes is as a rule carried out by hydrolytic condensation of trifunctional RSiY₃ precursors, where R denotes a hydrocarbon radical and Y denotes a hydrolysable group such as e.g. Cl, alkoxide or siloxide (Top. Curr. Chem. 1982, 102, 199-236). The reaction rate, degree of oligomerisation and yield accordingly depend on the concentration of RSiY₃ monomer, the solvent, the substituents R and Y, the temperature, the amount of added H₂O, and the catalyst. The use of acidic and basic catalysts for the hydrolytic condensation is described. As bases, apart from KOH there are also used Meₑ4NOH, Et₄NOH and trimethylbenzylammonium hydroxide. In general however the reaction times are very long and only extremely unsatisfactory yields are obtained. Nevertheless, various completely condensed silasesquioxanes of the formula R₈Si₈O₁₂ and of structure I 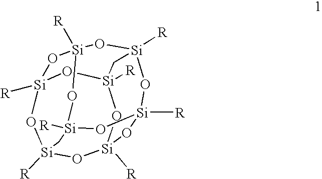
where R=C₅H₁₁, C₆H₁₁, C₆H₅, etc., are obtained by this method. The base-catalysed synthesis of the compound (isobutyl)₈Si₈O₁₂ is however not described.

Lichtenhan et al. likewise describe the base-catalysed production of oligomeric silasesquioxanes (WO 01/10871). At the same time the synthesis of the compound (isobutyl)₈Si₈O₁₂ starting from (isobutyl)SiCl₃ is also described. However, not only is it necessary to use toxic dichloromethane as solvent, in which the monomer is refluxed, but also the polysilasesquioxane [(isobutyl)SiO_{1.5}]_{∞} unfortunately has to be isolated as intermediate. A further disadvantage is the formation of HCl as byproduct of the hydrolytic condensation. The subsequent base-catalysed conversion of the polysilasesquioxane resin carried out in a separate reaction step using benzyltrimethylammonium hydroxide then yields [(isobutyl)₈Si₈O₁₂] in a relatively poor yield of 30%. The yield can be increased to 60% only by repeating the complicated reaction procedure three times.

The object of the invention was accordingly to provide an efficient process for the production of completely condensed oligomeric silasesquioxanes of the formula R¹ₐR²_{b}R³_{c}R⁴_{d}R⁵ₑR⁶_{f}R⁷_{g}R⁸ₕSi₈O₁₂ (R¹, R², R³, R⁴, R⁵, R⁶, R⁷, R⁸=substituted or unsubstituted alkyl, cycloalkyl, alkenyl, cycloalkenyl, alkinyl, cycloalkinyl, aryl or heteroaryl radicals or hydrogen; a+b+c+d+e+f+g+h=8) and of the structure 1, 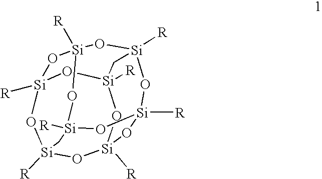
by means of which it is possible to produce silasesquioxanes of the formula R¹ₐR²_{b}R³_{c}R⁴_{d}R⁵ₑR⁶_{f}R⁷_{g}R⁸ₕSi₈O₁₂ and of the structure 1 directly in short reaction times and in high yields, possibly over 90%, without having to follow the indirect route via the synthesis of the polymeric silasesquioxanes.

It was surprisingly found that completely condensed oligomeric silasesquioxanes of the formula R¹ₐR²_{b}R³_{c}R⁴_{d}R⁵ₑR⁶_{f}R⁷_{g}R⁸ₕSi₈O₁₂ where R¹, R², R³, R⁴, R⁵, R⁶, R⁷, R⁸=identical or different, substituted or unsubstituted alkyl, cycloalkyl, alkenyl, cycloalkenyl, alkinyl, cycloalkinyl, aryl or heteroaryl radicals or hydrogen and a+b+c+d+e+f+g+h=8 and of the structure 1 can be produced after short reaction times and in extremely high yields by the procedure according to the invention. The indirect route via the isolation of polysilasesquioxanes as reaction intermediate is not necessary according to the process of the invention, and instead the monomeric compounds of the type RSiX₃ can be used directly as starting compounds, in which R=substituted or unsubstituted alkyl, cycloalkyl, alkenyl, cycloalkenyl, alkinyl, cycloalkinyl, aryl or heteroaryl radicals or hydrogen and X is a group capable of undergoing hydrolysis and/or condensation. The use of chlorinated solvents is also not necessary.

The present invention accordingly provides a process for the production of oligomeric, completely condensed silasesquioxanes of the formula R¹ₐR²_{b}R³_{c}R⁴_{d}R⁵ₑR⁶_{f}R⁷_{g}R⁸ₕSi₈O₁₂ and of the structure I 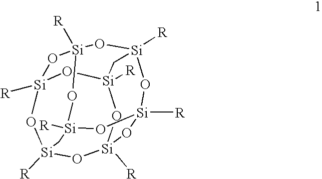
where R¹, R², R³, R⁴, R⁵, R⁶, R⁷, R⁸=identical or different, substituted or unsubstituted alkyl, cycloalkyl, alkenyl, cycloalkenyl, alkinyl, cycloalkinyl, aryl or heteroaryl radicals or hydrogen and a+b+c+d+e+f+g+h=8, which is characterised in that as educts monomeric compounds of the type RSiX₃ are reacted directly under base catalysis to form oligomeric silasesquioxanes of the formula R¹ₐR²_{b}R³_{c}R⁴_{d}R⁵ₑR⁶_{f}R⁷_{g}R⁸ₕSi₈O₁₂ in which R may be a substituted or unsubstituted alkyl, cycloalkyl, alkenyl, cycloalkenyl, alkinyl, cycloalkinyl, aryl or heteroaryl radicals or hydrogen and X denotes a group capable of undergoing hydrolysis and/or condensation, and in which the quantitative ratio of the sum of all educts of the type RSiX₃ to the base at the start of the reaction is 500:1 to 3:1.

The present invention also provides oligomeric silasesquioxanes produced by a process according to at least one of claims 1 to 24, as well as the use of these silasesquioxanes for the synthesis of not completely condensed silasesquioxanes, functionalised silasesquioxanes, catalysts and their starting compounds, as well as for the synthesis and modification of polymers.

The advantage of the present invention lies in the fact that silasesquioxanes of the formula R¹ₐR²_{b}R³_{c}R⁴_{d}R⁵ₑR⁶_{f}R⁷_{g}R⁸ₕSi₈O₁₂ and of the structure 1, which serve not only directly for applications involving the synthesis and modification of polymers but in addition as important starting substances for further derivatisations to form functionalised, incompletely condensed silasesquioxanes and a wide range of secondary products thereof that in turn can be used as starting substances for catalysts as well as for the synthesis and modification of polymers, can be obtained in high yield by means of a simple process. Up to now compounds of the structure 1 were accessible only in poor yields after long reaction times, in which connection in some cases the synthesis necessitated using the indirect route via polysilasesquioxanes as isolated intermediates.

In particular the provision of a particularly effective process for the production of [(isobutyl)₈Si₈O₁₂] is advantageous since the monomer precursor (isobutyl)SiX₃ (X=OMe, OEt, Cl) used as educt is accessible at low cost on a large industrial scale. In addition compounds of the formula R₈Si₈O₁₂ are therefore also of central importance in silasesquioxane chemistry since they can be reacted under base catalysis to form functionalised, incompletely condensed silasesquioxanes such as e.g. R₇Si₇O₉(OH)₃ 2 or also R₈Si₈O₁₁(OH)₂ 3 and R₈Si₈O₁₀(OH)₄ 4 (Chem. Commun. 1999, 2309-10; Polym. Mater. Sci. Eng. 2000, 82, 301-2; WO 01/10871) and may thus serve as parent compound for a large number of different incompletely condensed and functionalised silasesquioxanes, which in turn may be used for catalysts and their starting compounds as well as for the synthesis and modification of polymers.

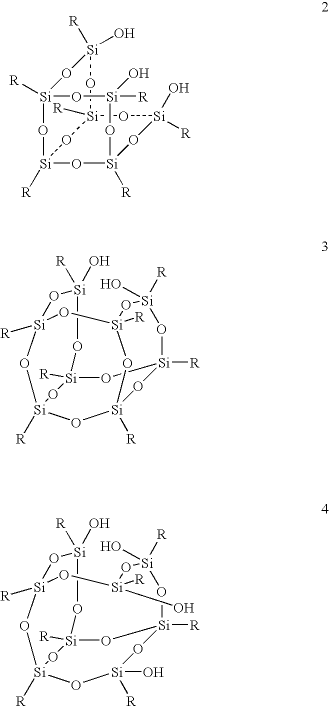

The process according to the invention is described hereinafter by way of example, without however intending to restrict the scope of the process. The process according to the invention for the production of oligomeric, completely condensed silasesquioxanes of the formula R¹ₐR²_{b}R³_{c}R⁴_{d}R⁵ₑR⁶_{f}R⁷_{g}R⁸ₕSi₈O₁₂ and of the structure 1 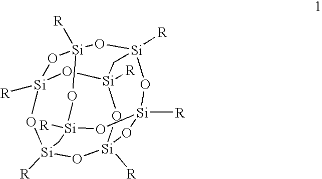
where R¹, R², R³, R⁴, R⁵, R⁶, R⁷, R⁸=identical or different, substituted or unsubstituted alkyl, cycloalkyl, alkenyl, cycloalkenyl, alkinyl, cycloalkinyl, aryl, heteroaryl radicals or hydrogen and a+b+c+d+e+f+g+h=8 is characterised by the fact that as educts monomeric compounds of the type RSiX₃ are directly converted under base catalysis to form oligomeric silasesquioxanes of the formula R¹ₐR²_{b}R³_{c}R⁴_{d}R⁵ₑR⁶_{f}R⁷_{g}R⁸ₕSi₈O₁₂, where R may be a substituted or unsubstituted alkyl, cycloalkyl, alkenyl, cycloalkenyl, alkinyl, cycloalkinyl, aryl or heteroaryl radicals or hydrogen and X denotes a group capable of undergoing hydrolysis and/or condensation, and in which the quantitative ratio of the sum of all educts of the type RSiX₃ to the base at the start of the reaction is 500:1 to 3:1. If relatively small quantitative ratios are used the yield of completely condensed silasesquioxanes becomes smaller, whereas the yield of not completely condensed silasesquioxanes increases.

The reaction is preferably carried out by adding the components to a reaction vessel. After the addition of the components or however also during the addition of the components care should be taken to ensure that the components are sufficiently thoroughly mixed in the reaction mixture. This may be achieved in a way and manner known to the person skilled in the art, for example by stirring or by producing turbulent flows.

Preferably there are used as educts monomeric compounds of the type RSiX₃ where X=OH, ONa, OK, OR′, OCOR′, OSiR′₃, Cl, Br, I or NR′₂, particularly preferably where X=OH, OR′, OCOR′ or Cl, where R′ is an organic radical. Most particularly preferably monomeric compounds of the type RSiX₃ where X=OR′, where R′ is an organic radical, are used as educts.

The use of bases as catalysts is necessary in order to control and/or accelerate the reaction. As basic catalysts there are preferably used compounds or ions selected from OH⁻, R′O⁻, R′COO⁻, R′NH⁻, R′CONR′⁻, R′⁻, CO₃²⁻, PO₄³⁻, SO₄²⁻, NO₃⁻, F⁻, NR′₃, R′₃NO, where R′ denotes an organic radical. Particularly preferably at least one compound selected from KOH, NaOH, (C₂H₅)₄NOH, C₆H₅CH₂(CH₃)₃NOH, (CH₃)₄NOH and (C₂H₅)₃N is used as basic catalyst. It is most particularly preferred to use alkali metal hydroxides such as KOH. The recitation of these examples does not restrict the invention in any way, since any arbitrary basic catalyst may be used.

The base-catalysed reaction takes place in solution. A polar solvent or also a non-polar solvent may be used as solvent. As solvents there are preferably used halogen-free solvents selected from the group comprising alcohols, ketones, aldehydes, ethers, acids, esters, anhydrides, alkanes, aromatic compounds and nitriles or mixtures of these solvents. Particularly preferably alcohols, ethers, acetone, acetonitrile, benzene or toluene are used as solvent. Most particularly preferably acetone, methanol or ethanol or a mixture of two or more of these compounds is used as solvent.

The concentration of the sum of all educts RSiX₃ in the reaction solution in the process according to the invention is preferably from 0.01 mole/l to 10 mole/l, more preferably 0.1 mole/l to 2 mole/l, particularly preferably 0.2 to 1 mole/l and most particularly preferably 0.3 to 0.8 mole/l. A monomer concentration of 0.5 mole/l is most particularly preferred.

A decisive factor for the success of the process is the quantitative ratio of the sum of all educts RSiX₃ that are used to the base that is used. In the process according to the invention this is from 500:1 to 3:1, preferably 100:1 to 5:1 and particularly preferably 50:1 to 10:1. A quantitative ratio of 25:1 is most particularly preferred. The use of larger amounts of base does not lead to the completely condensed oligomeric silasesquioxanes of the formula R¹ₐR²_{b}R³_{c}R⁴_{d}R⁵ₑR⁶_{f}R⁷_{g}R⁸ₕSi₈O₁₂ but to the formation of incompletely condensed oligomeric silasesquioxanes, as has been described for example in WO 01/10871, page 26, lines 13 to 21.

It may be advantageous to add water to the reaction mixture. In some cases however the existing traces of water in the solvent are also sufficient, or the reaction is carried out without the presence of water at the start of the reaction. A quantitative ratio of water to the sum of the educts RSiX₃ that are used of 1000:1 to 0.1:1, preferably 100:1 to 0.5:1, particularly preferably 50:1 to 1:1, is preferably employed for the production of the completely condensed oligomeric silasesquioxanes of the formula R¹ₐR²_{b}R³_{c}R⁴_{d}R⁵ₑR⁶_{f}R⁷_{g}R⁸ₕSi₈O₁₂ by the process according to the invention. Most particularly preferably a quantitative ratio of 10:1 to 2:1 is chosen.

The process according to the invention may be carried out at a temperature of −50° to 300° C., preferably at a temperature of 0° to 200° C., particularly preferably at a temperature of 20° to 100° C. Most particularly preferably the reaction is carried out at a temperature that lies below the boiling point of the reaction solution. It is also possible to change the temperature during the reaction. It may be advantageous to reduce the temperature towards the end of the reaction in order to isolate the product as fully as possible.

The process may be carried out continuously or in a batch operation.

After the end of the base-catalysed reaction the target product R¹ₐR²_{b}R³_{c}R⁴_{d}R⁵ₑR⁶_{f}R⁷_{g}R⁸ₕSi₈O₁₂ may be separated from the reaction mixture in a manner and way known to the person skilled in the art. Preferably the target product is precipitated from the reaction solution, in which connection the precipitation may be assisted by appropriate measures, such as for example salting-out or supercooling the solution.

Optionally a small amount of the target product R¹ₐR²_{b}R³_{c}R⁴_{d}R⁵ₑR⁶_{f}R⁷_{g}R⁸ₕSi₈O₁₂ may be added to the reaction solution at the start of the reaction in order to achieve a better precipitation of the target product.

The present invention also provides oligomeric silasesquioxanes of the type R¹ₐR²_{b}R³_{c}R⁴_{d}R⁵ₑR⁶_{f}R⁷_{g}R⁸ₕSi₈O₁₂ of the structure 1 where R¹, R², R³, R⁴, R⁵, R⁶, R⁷, R⁸=substituted or unsubstituted alkyl, cycloalkyl, alkenyl, cycloalkenyl, alkinyl, cycloalkinyl, aryl or heteroaryl radicals or hydrogen and a+b+c+d+e+f+g+h=8, produced by the process according to the invention.

These silasesquioxanes may be used for the synthesis and modification of polymers with a broad range of applications. Since the nature and the property profile of the silasesquioxanes can be varied in a wide range by on the one hand the R group itself, and on the other hand via a functionalisation, a combination with all accessible polymers is possible. An addition of suitable silasesquioxane products can favourably influence the rheological properties, the adhesive and composite properties as well as the blocking effect with respect to gases and liquids in a large number of polymers. Such organic polymers include for example polyolefins, amorphous poly(α-olefins), polyamides, copolyamides, polyamide compounds, polyesters, copolyesters, polyacrylates, polymethyl acrylates, polycarbonates, polyurethanes, phenol resins, epoxy resins, polysiloxanes, polysilanes, rubbers, rubber compounds, polyvinyl chloride, vinyl chloride copolymers, polystyrene, copolymers of styrene, ABS polymers and olefin copolymers and terpolymers. Polyolefins, polyethers, polyesters, polycarbonates, polyamides, polyurethanes, polyacrylates, polymethyl acrylates, polysiloxanes, polysilanes, phenol resins, epoxy resins, polyvinyl chloride and vinyl chloride copolymers, polystyrene and copolymers of styrene, ABS polymers and rubbers may also form composites by blending with the completely condensed oligomeric silasesquioxanes of the type R¹ₐR²_{b}R³_{c}R⁴_{d}R⁵ₑR⁶_{f}R⁷_{g}R⁸ₕSi₈O₁₂. The resulting polymers may be employed for example in the form of coatings, paints, injection moulded or extruded moulded articles, calendered sheets, lubricants, adhesives, cosmetics, pharmaceuticals, fibres, glass fibres or packaging materials. In addition they may also be used as bioactive and fungicidal products, for electronics materials, in space travel and for the production of medical prostheses.

Apart from the modification of the polymers by blending, it is also possible to apply the completely condensed oligomeric silasesquioxanes of the type R¹ₐR²_{b}R³_{c}R⁴_{d}R⁵ₑR⁶_{f}R⁷_{g}R⁸ₕSi₈O₁₂ to the polymer surface. The action of the completely condensed oligomeric silasesquioxanes of the type R¹ₐR²_{b}R³_{c}R⁴_{d}R⁵ₑR⁶_{f}R⁷_{g}R⁸ₕSi₈O₁₂ as polymer additives is due to the fact that, in the resulting polymers, they increase the glass transition temperature, decomposition temperature and thus the use temperature, improve the tear strength, impact strength, scratch resistance and mechanical hardness, reduce the density, thermal conductivity, coefficient of thermal expansion and dielectric constant and viscosity, alter the surface tension and adhesion, reduce the flammability, combustibility and generation of heat, increase the O₂ permeability and the oxidation and corrosion stability, simplify the processing, and inhibit shrinkage processes.

The compounds produced by the process according to the invention of the type R¹ₐR²_{b}R³_{c}R⁴_{d}R⁵ₑR⁶_{f}R⁷_{g}R⁸ₕSi₈O₁₂ (R¹, R², R³, R⁴, R⁵, R⁶, R⁷, R⁸=substituted or unsubstituted alkyl, cycloalkyl, alkenyl, cycloalkenyl, alkinyl, cycloalkinyl, aryl, heteroaryl radicals or hydrogen, a+b+c+d+e+f+g+h=8) may be used for the production of not completely condensed silasesquioxanes. Examples of not completely condensed silasesquioxanes are for example compounds of the types R₇Si₇O₉(OH)₃ 2, R₈Si₈O₁₁(OH)₂ 3 and R₈Si₈O₁₀(OH)₄ 4. These and other compounds for their part may now in turn be converted into variously functionalised silasesquioxanes. In particular compounds of the type R₇Si₇O₉(OH)₃ 2 can be converted by widely varying types of derivatisation to form a large number of valuable functionalised silasesquioxanes. These functionalised silasesquioxanes may for example contain oxy, hydroxy, alkoxy, silyl, silylalkoxy, carboxy, halogen, epoxy, ester, fluoroalkyl, isocyanate, acrylate, methacrylate, nitrile, alkenyl, alkinyl, amino, phosphine, siloxane, silane and silanol groups or saturated or unsaturated hydrocarbon radicals modified therewith. A subsequent modification and/or substitution of the radicals R is obviously also possible. The incompletely condensed silasesquioxanes as well as in particular the functionalised silasesquioxanes may for their part serve, by blending, grafting, polymerisation, copolymerisation as well as application to a surface, for the synthesis modification of polymers (e.g. polyolefins, polyethers, polyesters, polycarbonates, polyamides, polyurethanes, polyacrylates, polymethacrylates, polysiloxanes, polysilanes, phenol resins, epoxy resins, polyvinyl chloride and vinyl chloride copolymers, polystyrene and copolymers of styrene, ABS polymers and rubbers). The resulting polymers may similarly be used in the areas of application described hereinbefore for the completely condensed oligomeric silasesquioxanes of the type R¹ₐR²_{b}R³_{c}R⁴_{d}R⁵ₑR⁶_{f}R⁷_{g}R⁸ₕSi₈O₁₂, in which the incompletely condensed silasesquioxanes as well as the functionalised silasesquioxanes bring about the likewise previously described improvements in properties of the resulting polymers. Apart from their use as polymer additives, the incompletely condensed silasesquioxanes as well as the functionalised silasesquioxanes may also be used per se as pharmaceuticals, cosmetics, fungicides and bioactive agents.

The incompletely condensed silasesquioxanes as well as the functionalised silasesquioxanes that can be produced via the completely condensed oligomeric silasesquioxanes R¹ₐR²_{b}R³_{c}R⁴_{d}R⁵ₑR⁶_{f}R⁷_{g}R⁸ₕSi₈O₁₂ accessible by the process according to the invention may serve as starting compounds for catalysts. The incompletely condensed and/or functionalised silasesquioxanes may in this connection form homogeneous and heterogeneous catalysts by reaction with metal compounds, which catalysts for their part may be used for oxidations, metathesis, C—C coupling reactions, oligomerisations, polymerisations, additions, reductions, eliminations and rearrangements. Preferred in this connection is the reaction with metal compounds of metals of the subgroups including the lanthanides and actinides and metals of main groups III and IV.

Silasesquioxanes produced according to the invention may be used in particular in paints and printing inks in order to improve the rheological properties, the sedimentation behaviour, the application properties as well as the surface properties of the paint film or printing ink film.

The following examples are intended to illustrate the invention in more detail without restricting its scope:

### EXAMPLE 1

### Synthesis of (isobutyl)₈Si₈O₁₂ from (isobutyl)Si(OMe)₃

A solution of 6.4 g (0.11 mole) of KOH in 200 ml of H₂O is added to a solution of 446 g (2.5 mole) of isobutyltrimethoxysilane (isobutyl)Si(OMe)₃ in 4300 ml of acetone while stirring. The reaction mixture is then stirred for 3 days at 30° C. The resultant precipitate is filtered off and dried at 70° C. in vacuo. The product (isobutyl)₈Si₈O₁₂ is obtained in a yield of 262 g (96%).

Optionally 10 g of (isobutyl)₈Si₈O₁₂ may be added at the start of the reaction to achieve a better precipitation of the product.

Reaction parameters: [Si]=0.50 M, [OH⁻]=0.02 M, [H₂O]=2.2 M.

### EXAMPLE 2 (NOT ACCORDING TO THE INVENTION)

### Synthesis of (isobutyl)₈Si₈O₁₂ from (isobutyl)Si(OMe)₃ (WO 01/10871)

8.3 ml (0.05 mole) of (isobutyl)SiCl₃ are added to a mixture of 200 ml of CH₂Cl₂ and 5 ml of water while stirring vigorously. The mixture is then refluxed overnight. After cooling the reaction mixture, the CH₂Cl₂ phase is decanted off and dried over 5 g of CaCl₂. After evaporating the solvent polymeric [(isobutyl)SiO_{1.5}]_{∞} resin is obtained in quantitative yield. The ²⁹Si{¹H} NMR spectrum of the resin exhibits a broad resonance characteristic of silasesquioxane resins and no sharp resonance that can be associated with discrete polyhedric silasesquioxanes [(isobutyl)SiO_{1.5}]ₙ where n=6, 8, 10, 12, 14. The base-catalysed conversion of the polymeric [(isobutyl)SiO_{1.5}]_{∞} resin was accomplished by heating under reflux for 48 hours in 25 ml of methyl isobutyl ketone, in which connection sufficient C₆H₅CH₂N(CH₃)₃OH was added in order to form a strongly basic solution (ca. 2 ml of a 40% solution in methanol). After evaporating off the solvent (25° C., 0.01 torr) a resinous solid was obtained to which 15 ml of acetone were added. After filtration, 1.64 g (30% yield) of [(isobutyl)SiO_{1.5}]₈ are obtained as a white, microcrystalline solid. Evaporation of the acetone solution leads to further polymeric [(isobutyl)SiO_{1.5}]_{∞} resin, which after base-catalysed reaction yields further [(isobutyl)SiO_{1.5}]₈. The total yield after three base-catalysed conversions is typically greater than 60%.

### EXAMPLE 3

### Synthesis of (isobutyl)₇Si₇O₉(OH)₃ from (isobutyl)₈Si₈O₁₂ (Example of the synthesis of an incompletely condensed silasesquioxane)

55 g (63 mmole) of (isobutyl)₈Si₈O₁₂ in 500 ml of an acetone-methanol mixture (volume ratio 84:16) that contains 5.0 ml (278 mmole) of H₂O and 10.0 g (437 mmole) of LiOH are added at a temperature of 55° C. The reaction mixture is then stirred for 18 hours at 55° C. and following this is added to 500 ml of 1N hydrochloric acid. After stirring for 5 minutes the solid obtained is filtered off and washed with 100 ml of CH₃OH. After drying in air 54.8 g (96%) of (isobutyl)₇Si₇O₉(OH)₃ are obtained. Reaction parameters: [Si]=ca. 1.0 M, [OH⁻]=0.87 M, [H₂O]=0.56 M.

### EXAMPLE 4

### Reaction of (isobutyl)₇Si₇O₉(OH)₃ with 3-chloropropyltrimethoxysilane (Example of the synthesis of a functionalised silasesquioxane)

2.4 ml of 3-chloropropyltrimethoxysilane are added at 20° C. to a solution of 10.0 g (12.6 mmole) of (isobutyl)₇Si₇O₉(OH)₃ in 20 ml of THF. After addition of 0.5 ml of Et₄NOH (35% solution in H₂O, 1.2 mmole of base, 18 mmole of H₂O) the mixture is stirred overnight. 100 ml of MeOH are added to the resulting white suspension. After filtration the residue is washed twice with 50 ml of acetone. 6.0 g (60% yield) of 5 are obtained.

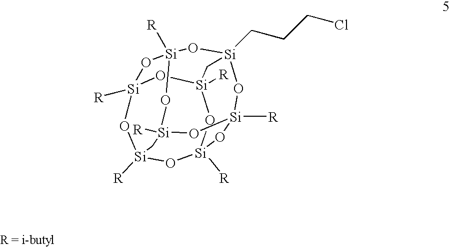

### EXAMPLE 5

### Reaction of (isobutyl)₇Si₇O₉(OH)₃ with Ti(O-i-Pr)₄ (Example of the synthesis of a catalyst)

0.91 ml (3 mmole) of Ti(O-i-Pr)₄ was added to 2.37 g (3 mmole) of (isobutyl)₇Si₇O₉(OH)₃ in 25 ml of hexane. This mixture was stirred for 1.5 hours at a temperature of 50° C. After completing the stirring the solvent was evaporated. 2.59 g of a white powder were obtained, which was identified by ¹H-NMR (CDCl₃) and ²⁹Si-NMR (CDCl₃) as the compound 6.

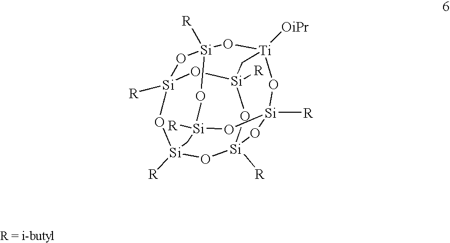

1-27. (canceled)

28. A process for the production of oligomeric, completely condensed silasesquioxanes of the formula R¹ₐR²_{b}R³_{c}R⁴_{d}R⁵ₑR⁶_{f}R⁷_{g}R⁸ₕSi₈O₁₂ and of the structure 1 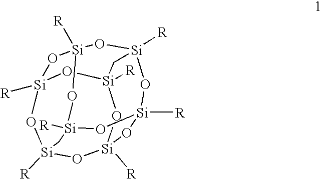
where R¹, R², R³, R⁴, R⁵, R⁶, R⁷, R⁸=identical or different, substituted or unsubstituted alkyl, cycloalkyl, alkenyl, cycloalkenyl, alkinyl, cycloalkinyl, aryl or heteroaryl radicals or hydrogen and a+b+c+d+e+f+g+h=8, comprising reacting as educts monomeric compounds of the formula RSiX₃ using base catalysis to form oligomeric silasesquioxanes of the formula R¹ₐR²_{b}R³_{c}R⁴_{d}R⁵ₑR⁶_{f}R⁷_{g}R⁸ₕSi₈O₁₂ in which R is a substituted or unsubstituted alkyl, cycloalkyl, alkenyl, cycloalkenyl, alkinyl, cycloalkinyl, aryl or heteroaryl radicals or hydrogen and X denotes a group capable of undergoing hydrolysis and/or condensation, and in which the quantitative ratio of the sum of all educts of formula RSiX₃ to the base at the start of the reaction is 500:1 to 3:1.

29. The process of claim 28, wherein X in said monomeric compounds of formula RSiX₃, is selected from the group consisting of: OH; ONa; OK; OR′; OCOR′; OSiR′₃; Cl; Br; I; and NR′₂ and wherein R′ denotes an organic radical.

30. The process of claim 29, wherein X is selected from the group consisting of: OH; OR′; OCOR′; and Cl and wherein R′ denotes an organic radical.

31. The process of claim 29, wherein the basic catalyst is a compound or an ion selected from the group consisting of: OH⁻; R′O⁻; R′COO⁻; R′NH⁻; R′CONR′⁻; R′⁻; CO₃²⁻; PO₄³⁻; SO₄²⁻; NO₃^{—}; F⁻; NR′₃; R′₃NO; and wherein R′ denotes an organic radical.

32. The process of claim 31, wherein said basic catalyst is selected from the group consisting of: KOH; NaOH; (C₂H₅)₄NOH; C₆H₅CH₂(CH₃)₃NOH; (CH₃)₄NOH; and (C₂H₅)₃N.

33. The process of claim 32, wherein said basic catalyst is KOH.

34. The process of claim 31, wherein the reaction is carried out in solution.

35. The process of claim 34, wherein said solution comprises a halogen-free solvent selected from the group consisting of: alcohols; ketones; aldehydes; ethers; acids; esters; anhydrides; alkanes; aromatic compounds; and nitriles or mixtures thereof.

36. The process of claim 35, wherein said solvent is acetone, methanol, ethanol or a mixture of two or more of these compounds.

37. The process of claim 35, wherein the quantitative ratio of the sum of all educts of formula RSiX₃ to the base is 100:1 to 5:1.

38. The process of claim 35, wherein the base-catalysed reaction is carried out in the presence of water.

39. The process of claim 38, wherein the quantitative ratio of the water used to the sum of all educts of formula RSiX₃ is 10:1 to 2:1.

40. The process of claim 38, wherein the base-catalysed reaction is carried out at a temperature of −50° C. to 300° C.

41. The process of claim 40, wherein the base-catalysed reaction is carried out at a temperature of 0° C. to 200° C.

42. The process of claim 34, wherein the production of the oligomeric silasesquioxanes is carried out at a temperature below the boiling point of the solvent.

43. The process of claim 34, wherein the sum of the starting concentrations of the educts of formula RSiX₃ in the solution is 0.01 mole/l to 10 mole/l.

44. The process of claim 43, wherein the sum of the starting concentrations of the educts of formula RSiX₃ in the solution is 0.3 mole/L to 0.8 mole/l.

45. The process of claim 28, wherein an oligomeric completely condensed silasesquioxane of the formula R₈Si₈O₁₂ is produced where R=substituted or unsubstituted alkyl, cycloalkyl, alkenyl, cycloalkenyl, alkinyl, cycloalkinyl, aryl or heteroaryl radicals or hydrogen.

46. The process of claim 45, wherein an oligomeric completely condensed silasesquioxane of the formula (isobutyl)₈Si₈O₁₂ is produced.

47. The process of claim 46, wherein, as educt for the production of (isobutyl)₈Si₈O₁₂, monomeric compounds of the type (isobutyl)SiX₃ are used in which X is a group capable of undergoing hydrolysis and/or condensation.

48. An amorphous poly(α-olefin); polyamide; copolyamide; polyamide compound; polyester; copolyester; plolyacrylate; polymethyl acrylate; polycarbonate; polyurethane; phenol resin; epoxy resin; polysiloxane; polysilane; rubber; rubber compound; polyvinyl chloride; vinyl chloride copolymer; polystyrene; copolymer of styrene; ABS polymer; or olefin copolymer or terpolymer comprising an oligomeric silasesquioxane produced by the process of claims 1.

49. A paint or printing ink comprising an oligomeric silasesquioxane produced by the process of claim 28.
